(19) United States
(12) Patent Application Publication
(10) Pub. No.: US 2015/0023279 A1
(43) Pub. Date: Jan. 22, 2015

(54) PRE-CODING DEVICE, WIRELESS TRANSMISSION DEVICE, WIRELESS RECEIVING DEVICE, WIRELESS COMMUNICATION SYSTEM, AND INTEGRATED CIRCUIT

(71) Applicant: Sharp Kabushiki Kaisha, Osaka-shi, Osaka (JP)

(72) Inventors: Hiromichi Tomeba, Osaka-shi (JP); Takashi Onodera, Osaka-shi (JP); Alvaro Ruiz Delgado, Osaka-shi (JP); Minoru Kubota, Osaka-shi (JP)

(73) Assignee: Sharp Kabushiki Kaisha, Osaka-shi, Osaka (JP)

(21) Appl. No.: 14/382,855

(22) PCT Filed: Mar. 4, 2013
(86) PCT No.: PCT/JP2013/055784

§ 371 Date: Sep. 4, 2014

(30) Foreign Application Priority Data
Mar. 6, 2012 (JP) 2012-049149

(51) Int. Cl. H04L 5/00; H04J 11/00; H04B 7/06; H04B 7/04; H04L 27/34

(52) U.S. Cl. CPC H04L 5/0051; H04B 7/0452; H04L 27/3455; H04B 7/0697; H04J 11/0033
USPC 370/329

(57) ABSTRACT

A terminal device knows which kind of pre-coding has been applied without increasing overhead in a wireless communication system in which plural kinds of pre-coding are selectively or simultaneously used.

A pre-coding device that is applied to a wireless communication device that performs wireless communication with a wireless receiving device applies, based on control information obtained from the wireless receiving device, the pre-coding to a data signal and plural kinds of specific reference signals, provides phase rotation to the plural kinds of specific reference signals, and associates phase rotation amounts of the phase rotation with information that is notified to the wireless receiving device.

### TECHNICAL FIELD

The present invention relates to a wireless communication technology.

### BACKGROUND ART

An improvement in a transmission speed is always desired in a wireless communication system in order to provide various kinds of broadband information services. The improvement in the transmission speed may be realized by expanding a communication bandwidth. However, spectral efficiency has to be improved because usable frequency bands are limited. As a technology that enables a significant improvement in the spectral efficiency, multiple input multiple output (MIMO) technology that performs wireless transmission by using a plurality of transmit and receive antennas has been attracting attention and practically used in cellular systems and wireless LAN systems. The improvement rate of the spectral efficiency by MIMO technology is proportional to the number of the transmit and receive antennas. However, the number of the receive antennas that may be arranged in a terminal device is limited. Thus, multi-user MIMO (MU-MIMO) is effective for the improvement in the spectral efficiency, in which a plurality of terminal devices that are simultaneously connected are regarded as an imaginary large scale antenna array and transmit signals from a base station device to the terminal devices are spatially multiplexed.

In the MU-MIMO, because the transmit signals addressed to the terminal devices are received as inter-user-interference (IUI) by the terminal devices, the IUI has to be suppressed. For example, Long Term Evolution (LTE) that is adopted as one of the 3.9-generation mobile wireless communication systems employs linear pre-coding that suppresses the IUI by multiplying in advance a linear filter that is calculated based on channel state information notified from the terminal devices at the base station device (the MU-MIMO based on the linear pre-coding will hereinafter be referred to as linear MU-MIMO in general). Further, employment of the linear MU-MIMO is expected in 802.11ac that has been standardized as a next generation wireless LAN system.

In addition, as a method of realizing the MU-MIMO that may facilitate a further improvement in the spectral efficiency, a MU-MIMO technology based on non-linear pre-coding in which non-linear signal processing is performed on the base station side has been attracting attention (the MU-MIMO based on non-linear pre-coding will hereinafter be referred to as non-linear MU-MIMO in general). In a case where remainder (modulo) computation is possible in the terminal device, addition of a perturbation vector that has a complex number in which an arbitrary Gaussian integer is multiplied by a certain real number (perturbation term) as a component to the transmit signal is enabled. Accordingly, when the perturbation vector is appropriately configured in accordance with the channel states between the base station device and the plurality of terminal devices, necessary transmission power may be largely reduced compared to the linear pre-coding. As the non-linear pre-coding, one method that may realize optimal transmission performances is vector perturbation (VP) that is described in NPL 1. Although the VP may realize high transmission performances, a computation amount exponentially increases proportionally to the number of terminals that are spatially multiplexed. Meanwhile, Tomlinson Harashima precoding (THP) that is described in NPL 2 needs almost the same computation amount as the linear pre-coding but is weak in the transmission performances, compared to the VP.

The non-linear MU-MIMO is effective for the improvement in the spectral efficiency of the MU-MIMO. However, it is important to retain backward compatibility when sophistication of the standard specification is discussed. This means that the linear pre-coding and the non-linear pre-coding are mixedly present as pre-coding methods in a case where the non-linear MU-MIMO is employed in a future standard for sophistication of the MU-MIMO.

Further, the non-linear MU-MIMO has a particular performance degradation factor that is referred to as modulo loss due to the modulo computation performed on the terminal device side. The modulo loss causes particularly significant influence in cases where receiving power acutely decreases, where phase modulation is used as a data modulation method, and so forth. To solve this problem, NPL 3 discusses hybrid THP that improves the transmission performances by adaptively changing application and non-application of the modulo computation to MU-MIMO transmission that uses the THP. In this case, the terminal device selectively receives a signal that needs the modulo computation for demodulation of the signal or a signal that does not need the modulo computation. In other words, a signal based on the linear pre-coding or a signal based on the non-linear pre-coding is selectively received.

### CITATION LIST

### Non Patent Literature

NPL 1: B. M. Hochwald, et. al., “A vector-perturbation technique for near-capacity multiantenna multiuser communication-Part II: Perturbation,” IEEE Trans. Commun., Vol. 53, No. 3, pp. 537-544, March 2005.

NPL 2: M. Joham, et. al., “MMSE approaches to multiuser spatio-temporal Tomlinson-Harashimaprecoding”, Proc. 5th ITG SCC04, pp. 387-394, January 2004.

NPL 3: Nakano et al., “Adaptive THP Scheme Control for Downlink MU-MIMO Systems”, IEICE Tech. Rep., RCS2009-293, March 2010.

NPL 4: IEEE 802.11-10/01119, “On DL precoding for 11ac,” MediaTek, September 2010.

### SUMMARY OF INVENTION

### Technical Problem

In a case where plural kinds of pre-coding have been selectively or simultaneously applied to a transmit signal, a terminal device needs to know which kind of pre-coding has been applied to the signal addressed to the terminal device so that a desired signal is correctly demodulated from the received signal. For example, NPL 4 discusses additional notification of control information that explicitly indicates which pre-coding method has been used. This method allows the terminal device to correctly know an applied pre-coding method but may result in a problem that overhead increases.

The present invention has been made in consideration of such a situation, and an object thereof is to provide a pre-coding device, a wireless transmission device, a wireless receiving device, a wireless communication system, and an integrated circuit that allow a terminal device to know which kind of pre-coding has been applied without increasing overhead in a wireless communication system in which plural kinds of pre-coding are selectively or simultaneously used.

### Solution to Problem

(1) To achieve the object, measures described below are employed in the present invention. That is, the pre-coding device of the present invention is a pre-coding device that is applied to a wireless transmission device that perform wireless communication with a wireless receiving device, in which the pre-coding device applies pre-coding to a data signal and plural kinds of specific reference signals based on control information that is obtained from the wireless receiving device, provides phase rotation to the plural kinds of specific reference signals, and associates phase rotation amounts of the phase rotation with information that is notified to the wireless receiving device.

As described above, the pre-coding device applies the pre-coding to the data signal and the plural kinds of specific reference signals based on the control information obtained from the wireless receiving device, provides the phase rotation to the plural kinds of specific reference signals, and associates the phase rotation amounts of the phase rotation with the information that is notified to the wireless receiving device. Accordingly, the wireless transmission device may transmit information bits by a portion of DMRSs, thus allowing contribution to a further improvement in spectral efficiency in MIMO transmission that performs the pre-coding.

(2) Further, in the pre-coding device of the present invention, the pre-coding device applies the pre-coding to the data signal and the plural kinds of specific reference signals by selectively or simultaneously using any pre-coding methods among plural kinds of pre-coding methods, and the phase rotation amounts of the phase rotation indicate the used pre-coding methods.

As described above, the phase rotation amounts of the phase rotation indicate the used pre-coding methods. Thus, in transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, a desired signal may correctly be demodulated from a received signal.

(3) Further, in the pre-coding device of the present invention, same phase rotation amounts of the phase rotation are provided to a first specific reference signal and a second specific reference signal in a case where linear pre-coding is applied to the data signal, and mutually different phase rotation amounts of the phase rotation are provided to the first specific reference signal and the second specific reference signal in a case where non-linear pre-coding is applied to the data signal.

As described above, the same phase rotation amounts of the phase rotation are provided to the first specific reference signal and the second specific reference signal in a case where the pre-coding device applies the linear pre-coding to the data signal, and the mutually different phase rotation amounts of the phase rotation are provided to the first specific reference signal and the second specific reference signal in a case where the pre-coding device applies the non-linear pre-coding to the data signal. Thus, in the transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, the desired signal may correctly be demodulated from the received signal.

(4) Further, a wireless transmission device of the present invention is a wireless transmission device that includes the pre-coding device according to any of above (1) to (3) and a plurality of transmit antennas and transmits data signals and specific reference signals to a plurality of wireless receiving devices, in which pre-coding that suppresses interference that is observed by the wireless receiving devices is applied, based on control information that is notified from the plurality of wireless receiving devices, to a portion of the data signals and the specific reference signals that are transmitted to the plurality of wireless receiving devices, and a portion of the data signals that are transmitted to the plurality of wireless receiving devices are transmitted while being spatially multiplexed using same radio resources.

As described above, the wireless transmission device applies the pre-coding that suppresses the interference that is observed by the wireless receiving devices to a portion of the data signals and the specific reference signals that are transmitted to the plurality of wireless receiving devices based on the control information that is notified from the plurality of wireless receiving devices and transmits a portion of the data signals that are transmitted to the plurality of wireless receiving devices by spatially multiplexing the portion of the data signal in the same radio resources. Thus, in a case of MU-MIMO transmission, a new pre-coding method may be added while backward compatibility is retained. This allows contribution to sophistication of wireless communication systems and to an improvement in the spectral efficiency.

(5) Further, a wireless receiving device of the present invention is a wireless receiving device that performs wireless communication with a wireless transmission device, in which the wireless receiving device notifies the wireless transmission device of control information, receives from the wireless transmission device a data signal and plural kinds of specific reference signals which are addressed to the wireless receiving device and to which pre-coding has been applied based on the notified control information, extracts phase rotation amounts of phase rotation that have been provided to the respective kinds of specific reference signals, and acquires information that is associated with the extracted phase rotation amounts.

As described above, the wireless receiving device extracts the phase rotation amounts of the phase rotation that are provided to the respective specific reference signals and acquires the information that is associated with the extracted phase rotation amounts. Accordingly, the wireless transmission device may transmit the information bits by a portion of the DMRSs, thus allowing contribution to a further improvement in the spectral efficiency in the MIMO transmission that performs the pre-coding.

(6) Further, in the wireless receiving device of the present invention, pre-coding that selectively or simultaneously uses any pre-coding methods among plural kinds of pre-coding methods has been applied to the data signal and the plural kinds of specific reference signals, and the used pre-coding methods are recognized and the received data signal is demodulated based on the phase rotation amounts.

As described above, the used pre-coding methods are recognized based on the phase rotation amounts, and the received data signal is thereby demodulated. Thus, in the transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, the desired signal may correctly be demodulated from the received signal.

(7) Further, in the wireless receiving device of the present invention, a determination is made that linear pre-coding has been applied to the data signal in a case where same phase rotation amounts of the phase rotation have been provided to a first specific reference signal and a second specific reference signal, a determination is made that non-linear pre-coding has been applied to the data signal in a case where mutually different phase rotation amounts of the phase rotation have been provided to the first specific reference signal and the second specific reference signal, and the received data signal is demodulated.

As described above, the wireless receiving device determines that the linear pre-coding has been applied to the data signal in a case where the same phase rotation amounts of the phase rotation have been provided to the first specific reference signal and the second specific reference signal and determines that the non-linear pre-coding has been applied to the data signal in a case where the mutually different phase rotation amounts of the phase rotation have been provided to the first specific reference signal and the second specific reference signal. Thus, in the transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, the desired signal may correctly be demodulated from the received signal.

(8) Further, in the wireless receiving device of the present invention, a determination is made that the non-linear pre-coding has been applied to the received signal regardless of the determination about the pre-coding methods based on the phase rotation amounts, and the data signal is demodulated.

As described above, the wireless receiving device determines that the non-linear pre-coding has been applied to the received signal regardless of the determination about the pre-coding methods based on the phase rotation amounts and thereby demodulates the data signal. Accordingly, more stable transmission performances may be obtained.

(9) Further, in the wireless receiving device of the present invention, a non-linear process that includes modulo computation is performed in a case where the non-linear pre-coding has been applied to the received data signal.

As described above, the wireless receiving device performs the non-linear process that includes the modulo computation in a case where the non-linear pre-coding has been applied to the received data signal. Thus, in the transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, the desired signal may correctly be demodulated from the received signal.

(10) A wireless communication system of the present invention is configured with the wireless transmission device according to above (4) and the wireless receiving device according to any of above (5) to (9).

As described above, the wireless communication system is configured with the wireless transmission device according to above (4) and the wireless receiving device according to any one of above (5) to (9). Accordingly, the wireless transmission device may transmit the information bits by a portion of the DMRSs, thus allowing contribution to a further improvement in the spectral efficiency in the MIMO transmission that performs the pre-coding.

(11) Further, an integrated circuit of the present invention is an integrated circuit, which is implemented in a wireless transmission device that performs wireless communication with a wireless receiving device and allows the wireless transmission device to execute a plurality of functions, the integrated circuit at least including: a function of obtaining control information from the wireless receiving device; a function of applying pre-coding to a data signal and plural kinds of specific reference signals, based on the control information, by selectively or simultaneously using either one pre-coding method of a linear pre-coding method and a non-linear pre-coding method; and a function of providing same phase rotation amounts of phase rotation to a first specific reference signal and a second specific reference signal in a case where linear pre-coding is applied to the data signal and providing mutually different phase rotation amounts of the phase rotation to the first specific reference signal and the second specific reference signal in a case where non-linear pre-coding is applied to the data signal, in which the phase rotation amounts of the phase rotation indicate the used pre-coding methods.

As described above, the same phase rotation amounts of the phase rotation are provided to the first specific reference signal and the second specific reference signal in a case where the wireless transmission device applies the linear pre-coding to the data signal, and the mutually different phase rotation amounts of the phase rotation are provided to the first specific reference signal and the second specific reference signal in a case where the wireless transmission device applies the non-linear pre-coding to the data signal. Thus, in the transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, the desired signal may correctly be demodulated from the received signal.

(12) Further, an integrated circuit of the present invention is an integrated circuit, which is implemented in a wireless receiving device that performs wireless communication with a wireless transmission device and allows the wireless receiving device to execute a plurality of functions, the integrated circuit at least including: a function of notifying the wireless transmission device of control information; a function of receiving from the wireless transmission device a data signal, a first specific reference signal, and a second specific reference signal which are addressed to the wireless receiving device and to which linear pre-coding or non-linear pre-coding has been applied based on the notified control information; a function of determining that the linear pre-coding has been applied to the data signal in a case where same phase rotation amounts of phase rotation have been provided to the first specific reference signal and the second specific reference signal and determining that the non-linear pre-coding has been applied to the data signal in a case where mutually different phase rotation amounts of the phase rotation have been provided to the first specific reference signal and the second specific reference signal; and a function of demodulating the received data signal based on a result of the determination.

As described above, the wireless receiving device determines that the linear pre-coding has been applied to the data signal in a case where the same phase rotation amounts of the phase rotation have been provided to the first specific reference signal and the second specific reference signal and determines that the non-linear pre-coding has been applied to the data signal in a case where the mutually different phase rotation amounts of the phase rotation have been provided to the first specific reference signal and the second specific reference signal. Thus, in the transmission that selectively uses the linear pre-coding and the non-linear pre-coding, the wireless receiving device may correctly know the actually applied pre-coding method although the wireless transmission device does not notify the wireless receiving device of the applied pre-coding method by the control information. Accordingly, the desired signal may correctly be demodulated from the received signal.

### Advantageous Effects of Invention

The present invention enables selective or simultaneous use of plural kinds of pre-coding without increasing overhead. Accordingly, a new pre-coding method may be added to a system in which a particular pre-coding method has already been a standard, thus allowing contribution to an improvement in spectral efficiency of the system.

### BRIEF DESCRIPTION OF DRAWINGS

FIG. 1 schematically illustrates a wireless communication system according to a first embodiment of the present invention.

FIG. 2 is a block diagram that illustrates a configuration of a base station device 1 according to the first embodiment of the present invention.

FIG. 3 illustrates an example of resource allocation for DMRSs and data signal in the first embodiment of the present invention.

FIG. 4 is a block diagram that illustrates a device configuration of an antenna unit 109 according to the first embodiment of the present invention.

FIG. 5 is a block diagram that illustrates a device configuration of a pre-coding unit 107A according to the first embodiment of the present invention.

FIG. 6 is a block diagram that illustrates a configuration of a terminal device 3 according to the first embodiment of the present invention.

FIG. 7 is a flowchart that explains signal processing on the DMRSs in a channel estimation unit 411 according to the first embodiment of the present invention.

FIG. 8 schematically illustrates a wireless communication system according to a second embodiment of the present invention.

FIG. 9 is a block diagram that illustrates a configuration of a base station device 1 according to the second embodiment of the present invention.

FIG. 10 illustrates an example of mapping of transmit data, the DMRSs, and a CRS in a case where the number Nt of transmit antennas is four and the number U of the connected terminal devices 3 is four in the second embodiment of the present invention.

FIG. 11 is a block diagram that illustrates a device configuration of a pre-coding unit 107B according to the second embodiment of the present invention.

FIG. 12 is a block diagram that illustrates a device configuration of a pre-coding unit 107C according to a third embodiment of the present invention.

FIG. 13 is a block diagram that illustrates a configuration of a terminal device 3 according to the third embodiment of the present invention.

FIG. 14 is a flowchart that explains signal processing in a case where the DMRSs are input in a channel estimation unit 801 of the terminal device 3 according to the third embodiment of the present invention.

### DESCRIPTION OF EMBODIMENTS

Embodiments in which a wireless communication system of the present invention is applied will hereinafter be described with reference to drawings. It should be noted that matters described in these embodiments are modes to facilitate understanding of the present invention, and it should not be construed that contents of the present invention are limited to the embodiments.

Hereinafter, A^{T} denotes a transposed matrix of a matrix A, A^{H} denotes an adjugate (Hermitian transpose) matrix of the matrix A, A⁻¹ denotes the inverse matrix of the matrix A, A⁺ denotes a pseudo-inverse (or generalized inverse) matrix of the matrix A, and diag(A) denotes a diagonal matrix that contains only diagonal components extracted from the matrix A, floor(c) denotes a floor function that returns a maximum Gaussian integer whose real part and imaginary part do not exceed the values of real and imaginary parts of a complex number c, E[x] denotes the ensemble average of a random variable x, abs(c) denotes a function that returns the amplitude of the complex number c, angle(c) denotes a function that returns the argument of the complex number c, ∥a∥ denotes the norm of a vector a, and x % y denotes the remainder of division of an integer x by an integer y. Further, [A;B] denotes a matrix in which two matrices A and B are coupled in the row direction, and [A,B] denotes a matrix in which the two matrices A and B are coupled in the column direction.

### 1. First Embodiment

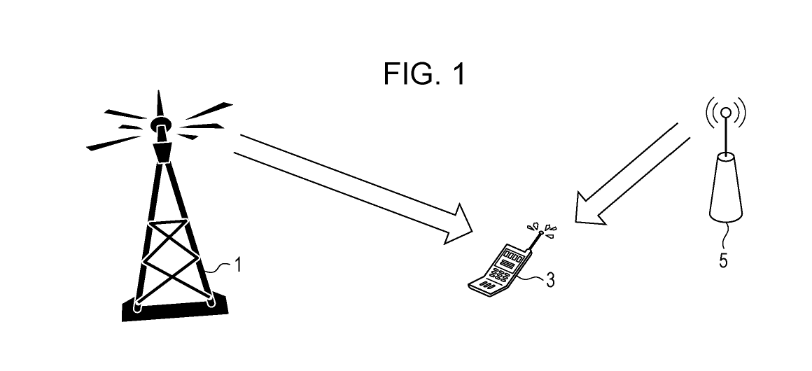

FIG. 1 schematically illustrates a wireless communication system according to a first embodiment of the present invention. In the first embodiment, discussion will be made about a case of one-to-one transmission in which a single terminal device (also referred to as wireless receiving device) 3 is connected with a base station device (also referred to as wireless transmission device) 1 that is capable of linear pre-coding and non-linear pre-coding. It is assumed that the terminal device 3 is in an environment where a signal transmitted from the base station device 1 (demanded signal or desired signal) and an interference signal sent out from an interference source 5 are received by the terminal device 3. Here, the interference signal is a signal that is transmitted using the same radio resource as the demanded signal but is different from the demanded signal. An example is co-channel interference (or inter-cell interference) or the like in a cellular system that performs frequency reuse. It is also assumed that orthogonal frequency division multiplexing (OFDM) that has Nc sub-carriers is used as a transmission method. The base station device 1 obtains information of the interference signal that is received by the terminal device 3 through control information that is notified by the terminal device 3 and performs pre-coding on transmit data with respect to each of the sub-carriers based on the interference signal information. Each of the base station device 1 and the terminal device 3 includes a single antenna, a channel between the base station device 1 and the terminal device 3 is an AWGN channel that takes into account thermal noise applied in the terminal device 3.

[1.1. Base Station Device 1]

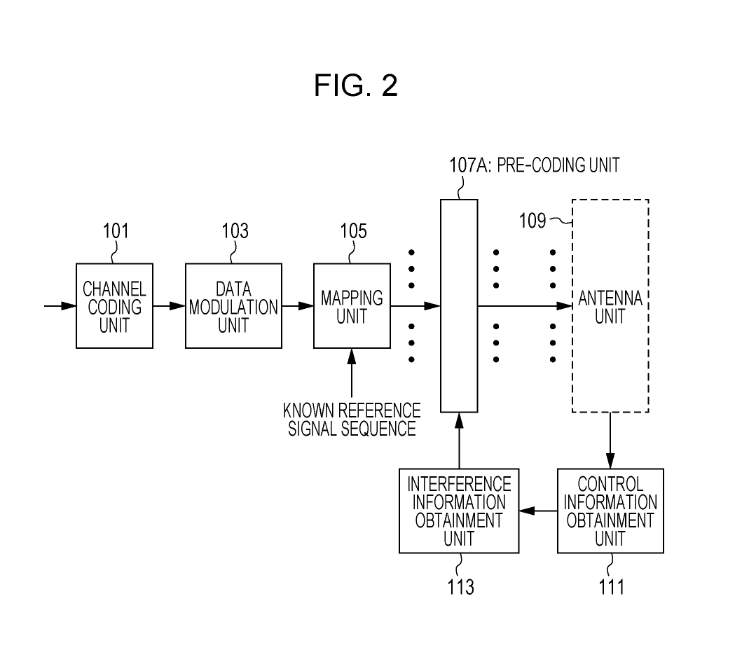

FIG. 2 is a block diagram that illustrates a configuration of the base station device 1 according to the first embodiment of the present invention. As illustrated in FIG. 2, the base station device 1 is configured to include a channel coding unit 101, a data modulation unit 103, a mapping unit 105, a pre-coding units 107A (hereinafter, pre-coding units 107A, 107B, 107C, . . . will also be collectively referred to as pre-coding unit 107), antenna units 109, a control information obtainment unit 111, and an interference information obtainment unit 113. The pre-coding units 107A corresponding to the number N_{c} of the sub-carriers are present. Channel coding is performed on a transmit data sequence that is addressed to the terminal device 3 in the channel coding unit 101. Digital data modulation such as QPSK or 16QAM is thereafter applied to the transmit data sequence by the data modulation unit 103. An output from the data modulation unit 103 is input to the mapping unit 105.

The mapping unit 105 performs mapping (also referred to as scheduling or resource allocation) for arranging data to specified radio resources (also referred to as resource elements or simply as resources). The radio resources herein are mainly frequencies and time. Radio resources to be used are determined based on reception quality or the like that is observed by the terminal device 3. In this embodiment, it is assumed that the radio resources to be used are predetermined and known by both of the base station device 1 and the terminal device 3. The mapping unit 105 multiplexes a known reference signal sequence for performing channel estimation in the terminal device 3.

The reference signals that are addressed to the terminal device 3 are multiplexed to be mutually orthogonal so that the reference signals may be demultiplexed from a data signal in the terminal device 3 that receives the signals. In this embodiment, a demodulation reference signal (DMRS) that is a specific reference signal for demodulation is multiplexed. However, a configuration in which another reference signal is further multiplexed is possible. The DMRS is periodically transmitted with respect to time and frequency resources.

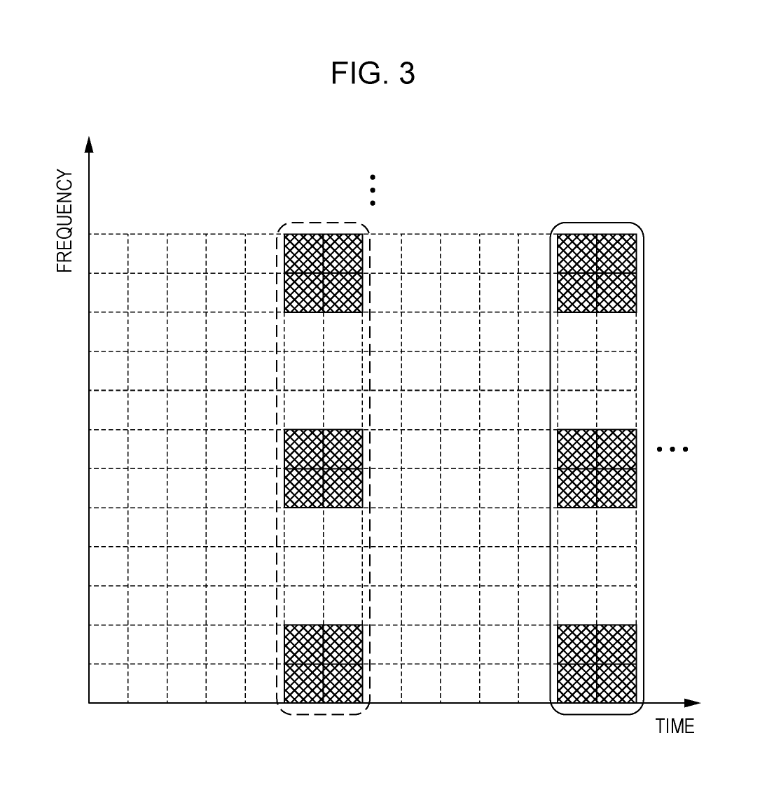

FIG. 3 illustrates an example of resource allocation for DMRSs and the data signal in the first embodiment of the present invention. The horizontal axis represents time (OFDM signal numbers), and the vertical axis represents frequency (sub-carrier numbers). A portion of all the radio resources are illustrated in FIG. 3. However, it may be considered that such arrangement is repeated in the time and frequency directions. The DMRSs are transmitted by the resources that are shaded by cross-hatching. However, phase rotation in response to a pre-coding method that will be described later is applied to the DMRS surrounded by a broken line (this will hereinafter be referred to as a second DMRS), differently from the DMRS surrounded by a solid line (this will hereinafter be referred to as a first DMRS). Details will be described later.

Returning to FIG. 2, outputs of the mapping unit 105 are input to the pre-coding units 107A of the corresponding sub-carriers. A description about signal processing in the pre-coding units 107A will be made later. Hereinafter, signal processing on outputs of the pre-coding units 107A will first be described. Outputs of the pre-coding units 107A of the sub-carriers are input to the antenna units 109 of the corresponding transmit antennas.

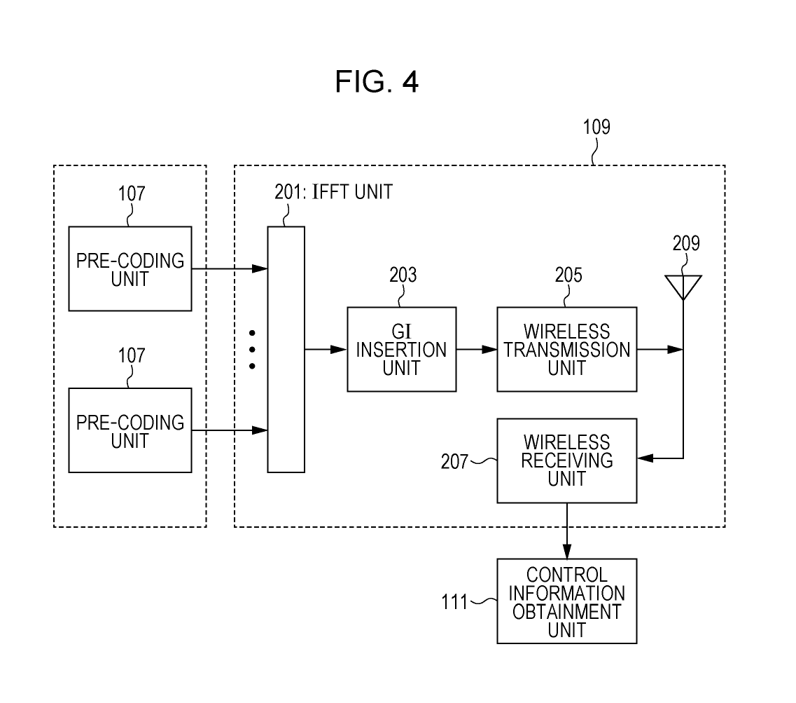

FIG. 4 is a block diagram that illustrates a device configuration of the antenna unit 109 according to the first embodiment of the present invention. As illustrated in FIG. 4, the antenna unit 109 is configured to include an IFFT unit 201, a GI insertion unit 203, a wireless transmission unit 205, a wireless receiving unit 207, and an antenna 209. In the antenna unit 109, an output of the corresponding pre-coding unit 107A is input to the IFFT unit 201, inverse fast Fourier transform (IFFT) or inverse discrete Fourier transform (IDFT) of N_{c} points is applied to the output, and an OFDM signal that has N_{c} sub-carriers is thereby generated and output from the IFFT unit 201. Here, a description is made about a case where the number of the sub-carriers is the same as the number of the points of the inverse discrete Fourier transform. However, in a case where guard bands are configured in a frequency area, the number of the points is greater than the number of the sub-carriers. The output of the IFFT unit 201 is input to the GI insertion unit 203, added with guard intervals, and input to the wireless transmission unit 205. In the wireless transmission unit 205, a transmit signal in a baseband is converted into a transmit signal in a radio frequency (RF) band. Output signals of the wireless transmission unit 205 are transmitted from the antenna 209.

Information that is associated with an interference signal estimated by the terminal device 3 is received by the wireless receiving unit 207 and is output to the control information obtainment unit 111.

[1.2. Pre-Coding Unit 107A]

The signal processing that is performed in the pre-coding unit 107A will be described. The pre-coding unit 107A of a kth sub-carrier will be described below. A description will first be made about a case where a data signal component among the outputs of the mapping unit 105 is input.

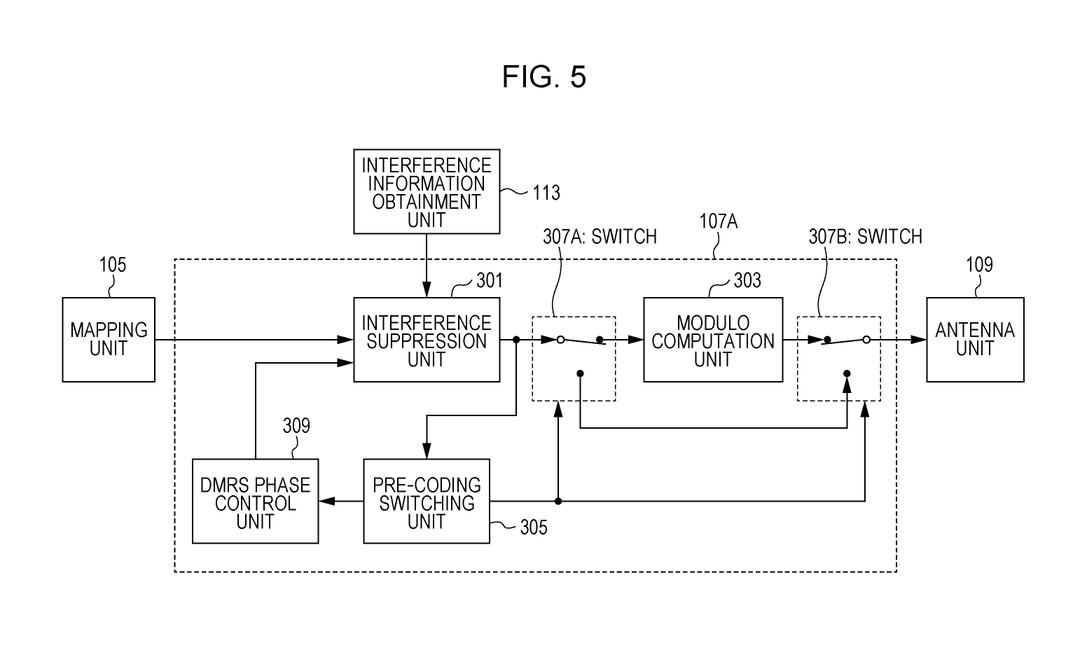

FIG. 5 is a block diagram that illustrates a device configuration of the pre-coding unit 107A according to the first embodiment of the present invention. As illustrated in FIG. 5, the pre-coding unit 107A is configured to include an interference suppression unit 301, a modulo computation unit 303, a pre-coding switching unit 305, a switch 307A, a switch 307B, and a DMRS phase control unit 309. A kth sub-carrier component {d(k)} of the output of the mapping unit 105 that contains the transmit data addressed to the terminal device 3 and an interference signal {i(k)} that is received by the terminal device 3 are input to the pre-coding unit 107A. In the description made below, it is assumed that the interference signal {i(k)} is ideally obtained by the interference information obtainment unit 113, and an index k will be omitted for convenience.

An interference suppression process is first applied to transmit data d in the interference suppression unit 301. Specifically, a transmit code x (=d−i) that is obtained by subtracting an interference signal i from the transmit data d and a transmit signal s (=β(d−i)) that is obtained by multiplying the transmit code x by a power normalization term β are output as outputs of the interference suppression unit 301. The transmit code x among those is input to the pre-coding switching unit 305. In a case where the transmit data are input to the interference suppression unit 301, no particular information is input from the DMRS phase control unit 309.

The pre-coding switching unit 305 calculates the power of the input transmit code x, that is, Pₓ=|d−i|². The power Pₓ varies in response to the interference signal i. In a case where Pₓ is greater than a predetermined threshold value, the switch 307A and the switch 307B are controlled such that the transmit code x is output from the interference suppression unit 301 to the modulo computation unit 303. In a case where Pₓ is smaller than the threshold value, the switch 307A and the switch 307B are controlled such that the transmit signal s is output from the interference suppression unit 301 to the antenna unit 109. The threshold value may in advance be determined by a calculator simulation or the like. Further, information of how the switches are turned is input to the DMRS phase control unit 309.

In a case where the transmit code x is input from the pre-coding switching unit 305 to the modulo computation unit 303, the modulo computation unit 303 applies modulo computation of a modulo width δ to the transmit code x.

Modulo computation mods(x) of the modulo width δ is computation that adds an arbitrary Gaussian integer to an arbitrary input complex number x and thereby returns a complex number whose real part and imaginary part are both larger than −δ and smaller than δ. This computation is expressed by equations (1).

$$\begin{matrix}[ Math . 1 ] & \\ {mod}_{δ} ( x ) = x - 2 δ floor ( \frac{x}{2 δ} + \frac{1 + j}{2} ) = x + 2 δ z \\ z = - floor ( \frac{x}{2 δ} + \frac{1 + j}{2} ) & ( 1 )\end{matrix}$$

An average power of the output of the modulo computation that is expressed by equations (1) becomes (⅔)×δ² with respect to the average power of the original transmit data and may thus be made a uniform average transmission power regardless of the value of interference power. This is equivalent to assuming that the transmit signal is multiplied by β=((⅔)×δ²)^{-1/2} as the power normalization term β. The value of δ is not particularly limited as long as the value is shared by the base station device 1 and the terminal device 3. However, a value that minimizes average bit error rate (BER) with respect to provided transmission power is usually selected. The value depends on a data modulation method that is applied to d and is 2^{1/2} in a case of the QPSK modulation and 4×10^{-1/2} in a case of the 16QAM, for example.

Hereinafter, the pre-coding will be referred to as non-linear pre-coding in a case where the modulo computation is performed and as linear pre-coding in a case where the modulo computation is not performed. That is, the pre-coding switching unit 305 switches the linear pre-coding and the non-linear pre-coding based on the power of the input transmit code. An output of the modulo computation unit 303 or an output of the interference suppression unit 301 is output to the antenna unit 109 as an output of the pre-coding unit 107A.

The kinds of pre-coding may be switched for each of the radio resources. However, because the terminal device 3 needs to know which kind of pre-coding has been applied, it is not preferable to switch the kinds of pre-coding in very short periods. A description will be made below on an assumption that the kinds of pre-coding are switched by the resource block (RB) where a single block is formed of 168 radio resources that are configured with 12 sub-carriers contained in 14 OFDM symbols illustrated in FIG. 3. However, the number of resources that are contained in the RB is not limited to this.

Which of the linear pre-coding and the non-linear pre-coding is used is determined in accordance with power of the interference signal. In a case where the interference signal fluctuates in the time or frequency direction, the pre-coding methods are changed with respect to the time or frequency direction. Because signal demodulation methods of the terminal device 3 that will be described later are changed in accordance with the applied pre-coding method, the terminal device 3 needs to know which kind of pre-coding has been applied. Thus, in this embodiment, a phase of a signal sequence used for the DMRS that is transmitted to the terminal device 3 is changed, thereby allowing the terminal device 3 to know which pre-coding method has been applied.

A case where the DMRSs are input to the pre-coding unit 107A will be described. Returning to FIG. 3, the DMRS is periodically transmitted with respect to time-frequency directions in the time direction. In FIG. 3, C_{DMRS}=|c₁, c₂, . . . , c_{Np}} is used as the signal sequence for the first DMRS that is surrounded by the solid line. Although {cₙ} may be an arbitrary complex number, both of the base station device 1 and the terminal device 3 need to know {cₙ}. The symbol Nₚ denotes a signal sequence length of the DMRS, and Nₚ=12 in FIG. 3 as an example. In addition, signal sequences to be used are changed in accordance with the pre-coding method that is applied to the data signal component for the second DMRS that is surrounded by the broken line. Thus, the DMRS phase control unit 309 determines the phase rotation amount that is provided to the second DMRS based on information input from the pre-coding switching unit 305 about the pre-coding method that is applied to the transmit data and inputs the information to the interference suppression unit 301. The interference suppression unit 301 applies the phase rotation to the second DMRS based on the information that is input from the DMRS phase control unit 309. For example, the CDMRS is used as the signal sequence without any change in a case where the pre-coding method is the linear pre-coding. In a case where the pre-coding method is the non-linear pre-coding, as the signal sequence, a sequence |c₁, −c₂, c₃, −c₄, . . . , c_{Np}} in which the phase rotation of n is provided to the CDMRS may be used as the signal sequence. Although the phase rotation amount is π in this case, any phase rotation amount may be provided as long as both of the base station device 1 and the terminal device 3 know the phase rotation amount. Further, the signal sequence length may be an arbitrary length.

The DMRS is used to estimate information (channel state information) that allows the terminal device 3 to demodulate a desired signal from a receive signal. In a case of the first embodiment, the information that the terminal device 3 desires to estimate is the power normalization term that is multiplied to the transmit signal. Thus, a similar interference suppression process to the one for the data signal is applied to the DMRS that is a known signal in the pre-coding unit 107A, thereby allowing the terminal device 3 to estimate the power normalization term. Then, the pre-coding switching unit 305 determines whether or not the phase rotation is provided to the C_{DMRS}. However, the modulo computation is applied to the DMRS also in a case where the non-linear pre-coding is applied. In this case, because a signal in which a perturbation term is added to the DMRS is received by the terminal device 3, the power normalization term may not be correctly estimated. Accordingly, the DMRS is transmitted with the linear pre-coding even if the non-linear pre-coding is applied to the data signal. Here, because the power normalization term needs to be the same as the data signal, the transmission power of the DMRS slightly increases compared to the data signal. The non-linear pre-coding may be applied to the DMRS as long as the terminal device 3 may correctly estimate the perturbation term that is added to the DMRS by another method.

In the above description, the proportions of the first DMRS and the second DMRS to all the radio resources are the same. However, the proportions of the first and second DMRSs may not be the same. Further, the power normalization does not necessarily have to be performed for each of the radio resources, and normalization may be performed such that average transmission power becomes uniform to each plurality of radio resources (for example, each of the RBs).

[1.3. Terminal Device 3]

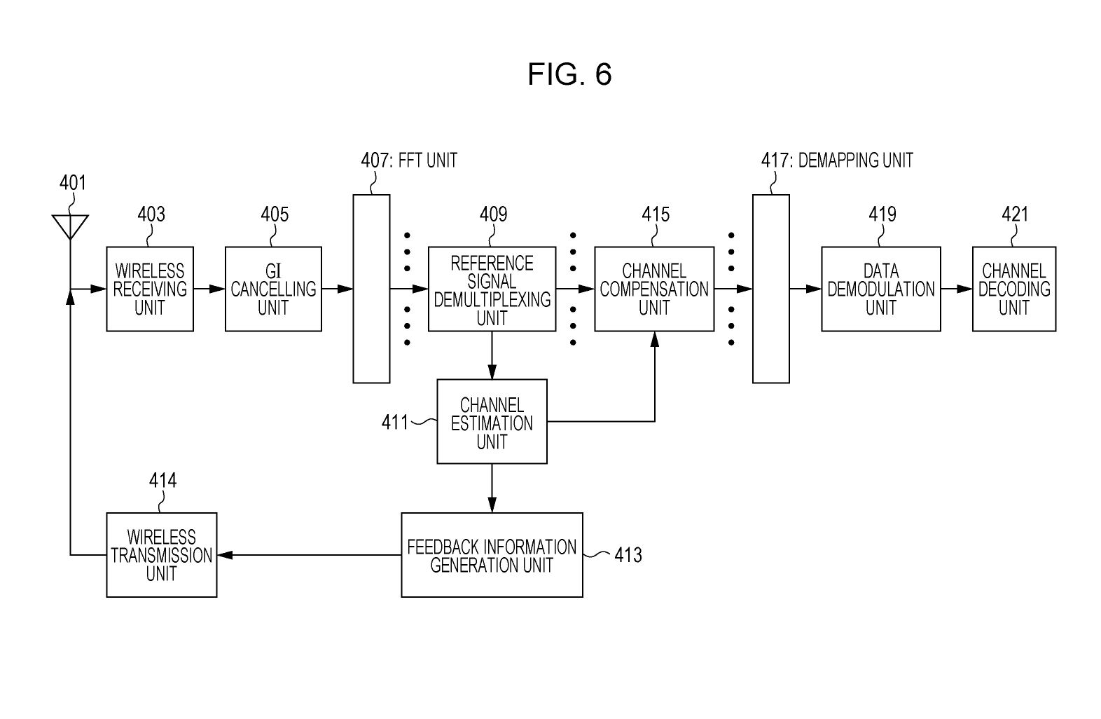

FIG. 6 is a block diagram that illustrates a configuration of the terminal device 3 according to the first embodiment of the present invention. As illustrated in FIG. 6, the terminal device 3 is configured to include an antenna 401, a wireless receiving unit 403, a GI cancelling unit 405, FFT units 407, reference signal demultiplexing units 409, a channel estimation unit 411, a feedback information generation unit 413, a wireless transmission unit 414, channel compensation units 415, a demapping unit 417, a data demodulation unit 419, and a channel decoding unit 421.

In the terminal device 3, a signal that is received by the antenna 401 is input to the wireless receiving unit 403 and converted into a signal in the baseband. The converted baseband signal is input to the GI cancelling unit 405, has the guard intervals removed therefrom, and thereafter input to the FFT unit 407. The FFT unit 407 applies the fast Fourier transform (FFT) or the discrete Fourier transform (DFT) of N_{c} points to the input signal and converts the signal into N_{c} sub-carrier components. An output of the FFT unit 407 is input to the reference signal demultiplexing unit 409. The reference signal demultiplexing unit 409 demultiplexes the input signal into the data signal component and a DMRS component. Further, the data signal component is output to the channel compensation unit 415, and the DMRSs are output to the channel estimation unit 411. Signal processing described below is basically performed for each of the sub-carriers.

The channel estimation unit 411 performs channel estimation based on the DMRSs that are input known reference signals and performs estimation of the pre-coding method that is presently applied by the base station device 1.

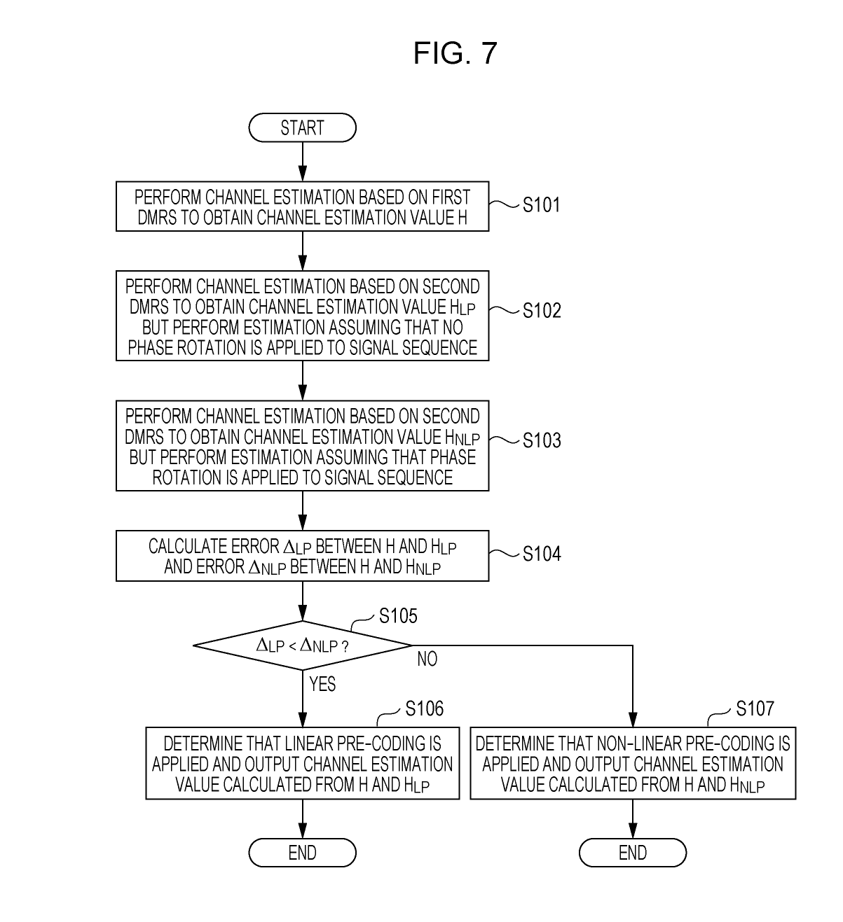

FIG. 7 is a flowchart that explains the signal processing on the DMRSs in the channel estimation unit 411 according to the first embodiment of the present invention. The signal processing on the DMRSs will be described below based on the flowchart illustrated in FIG. 7.

The channel estimation unit 411 first performs the channel estimation based on the first DMRS (step S101). Because the first DMRS uses the C_{DMRS} as the signal sequence, reverse modulation is performed on the C_{DMRS}, and channel state information H may thereby be estimated.

On the other hand, the second DMRS uses the C_{DMRS} without any change or the sequence in which the phase rotation of π is applied to the C_{DMRS} in accordance with the pre-coding method that is applied to the data signal. Thus, the channel estimation unit 411 applies the reverse modulation to the radio resources by which the second DMRS is received based on each sequence to calculate two channel estimation values of channel estimation values H_{LP} and H_{NLP} (step S102 and step S103).

Next, respective errors Δ_{LP} and Δ_{NLP} between H_{LP} and H_{NLP} that are estimated by the second DMRS and the channel state information H that is estimated by the first DMRS are calculated (step S104). Although any information may be used as information that indicates an error, the squared error between H_{LP} and H may be calculated, for example. Further, in a case where the DMRS is transmitted using the plurality of radio resources as this embodiment, the mean squared error between plural H_{LP} and H that are estimated may be calculated.

Next, the pre-coding method that is performed by the base station device 1 is estimated based on the calculated errors Δ_{LP} and Δ_{NLP}. Specifically, if Δ_{LP}<Δ_{NLP} (step S105: YES), a determination is made that the used pre-coding method is the linear pre-coding. If Δ_{LP}<Δ_{NLP} does not hold true (step S105: NO), a determination is made that the pre-coding method is the non-linear pre-coding. Finally, the channel state information that is estimated by the first and second DMRSs and an estimation result of the pre-coding method are output to the channel compensation unit 415 as outputs of the channel estimation unit 411 (step S106 and step S107). For example, if the determination is the linear pre-coding, a final channel estimation value is output by using H and H_{LP}. An average of H and H_{LP} may be output, or a result obtained by application of proper interpolation may be output. In a case where the determination is the non-linear pre-coding, a final channel estimation value is output by using H and H_{NLP}.

In a case where receiving power is very low or where the calculated error (the difference between Δ_{LP} and Δ_{NLP}) is very small, estimation accuracy of the pre-coding method becomes very low. Thus, in a case where the difference between Δ_{LP} and Δ_{NLP} is smaller than a predetermined threshold value, the channel estimation unit 411 may determine that the pre-coding method applied to the data signal is the non-linear pre-coding. As already described, transmission performances degrade unless the terminal device 3 demodulates signals by appropriate demodulation methods that are determined for the respective pre-coding methods. However, the degradation of the transmission performances in a case where signals to which the linear pre-coding has been applied are demodulated as signals to which the non-linear pre-coding has been applied is lower than the degradation of the transmission performances in a case where the signals to which the non-linear pre-coding has been applied are demodulated as the signal to which the linear pre-coding has been applied. Accordingly, in a case where the estimation accuracy of the pre-coding method is very low, more stable transmission performances may be obtained by always demodulating the signals assuming that the non-linear pre-coding has been applied.

The channel estimation unit 411 also estimates the interference signal. Estimation of the interference signal is enabled by partially configuring radio resources by which the base station device 1 sends no signal (carrier holes) or by transmitting a known reference signal to which no pre-coding is applied separately from the DMRSs. The estimated interference signal is output to the feedback information generation unit 413 and converted into a signal that may be notified to the base station device 1. Here, the estimated interference signal may be quantized by a finite number of bits, or the estimated interference signal may be transmitted as the transmit signal without any change. An output of the feedback information generation unit 413 is sent to the wireless transmission unit 414 and finally transmitted to the base station device 1. The process described above is the signal processing in the channel estimation unit 411.

Returning to FIG. 6, the data signal component and the channel estimation value and an estimation value of the pre-coding method that are estimated by the channel estimation unit 411 are input to the channel compensation unit 415. The channel compensation unit 415 first applies channel equalization process by using the channel estimation value. In a case of this embodiment, simple synchronous detection in which the receive signal is divided by the channel estimation value may be performed as the channel equalization process. After the channel equalization process is applied, signal processing based on the estimation result of the pre-coding method is applied.

In a case where it is estimated that the linear pre-coding has been applied as the pre-coding method, the signal on which the channel equalization process is performed is output to the demapping unit 417 without any change as an output of the channel compensation unit 415. On the other hand, in a case where it is estimated that the non-linear pre-coding has been applied, the modulo computation of the same modulo width as the modulo computation that has been applied by the pre-coding unit 107A of the base station device 1 is applied to the signal on which the channel equalization process is performed, and a modulo computation result is output to the demapping unit 417 as the output of the channel compensation unit 415.

In the demapping unit 417, the terminal device 3 extracts the transmit data addressed to the device from radio resources that are used for transmission of the transmit data addressed to the device. A configuration is possible in which an output of the reference signal demultiplexing unit 409 is first input to the demapping unit 417 and only a radio resource component that corresponds to the device is input to the channel compensation unit 415. An output of the demapping unit 417 is thereafter input to the data demodulation unit 419 and the channel decoding unit 421, and data demodulation and channel decoding are performed.

In accordance with a method of the channel decoding that is performed in the channel decoding unit 421, direct decoding is possible by using a signal to which the perturbation term is added. In this case, even in a case where the channel estimation unit 411 estimates that the non-linear pre-coding is performed by the base station device 1, the modulo computation is not performed by the channel compensation unit 415, and estimation information that indicates which pre-coding method is used is input to the channel decoding unit 421. The channel decoding unit 421 may determine a channel decoding method based on the estimation result of the pre-coding method.

In this embodiment, it is assumed that OFDM signal transmission is performed and the pre-coding is performed for each of the sub-carriers. However, a transmission method (or an access method) or a unit to which the pre-coding is applied is not limited. For example, this embodiment may be applied to a case where the pre-coding is performed on each resource block in which a plurality of sub-carriers are combined and may similarly be applied to a single-carrier-based access method (for example, a single-carrier frequency-division multiple access (SC-FDMA) method or the like).

By the method described above, in transmission that selectively uses the linear pre-coding and the non-linear pre-coding, the terminal device 3 may correctly know the actually applied pre-coding method without notification of the applied pre-coding method by the control information. Accordingly, the desired signal may correctly be demodulated from the received signal.

### 2. Second Embodiment

In the first embodiment, discussion is made about a case where the one-to-one transmission is performed in which the single base station device 1 and the single terminal device 3 are present. In a second embodiment, discussion will be made about multi-user MIMO (MU-MIMO) transmission where a base station device that includes a plurality of transmit antennas and a plurality of terminal devices perform simultaneous communication using same radio resources.

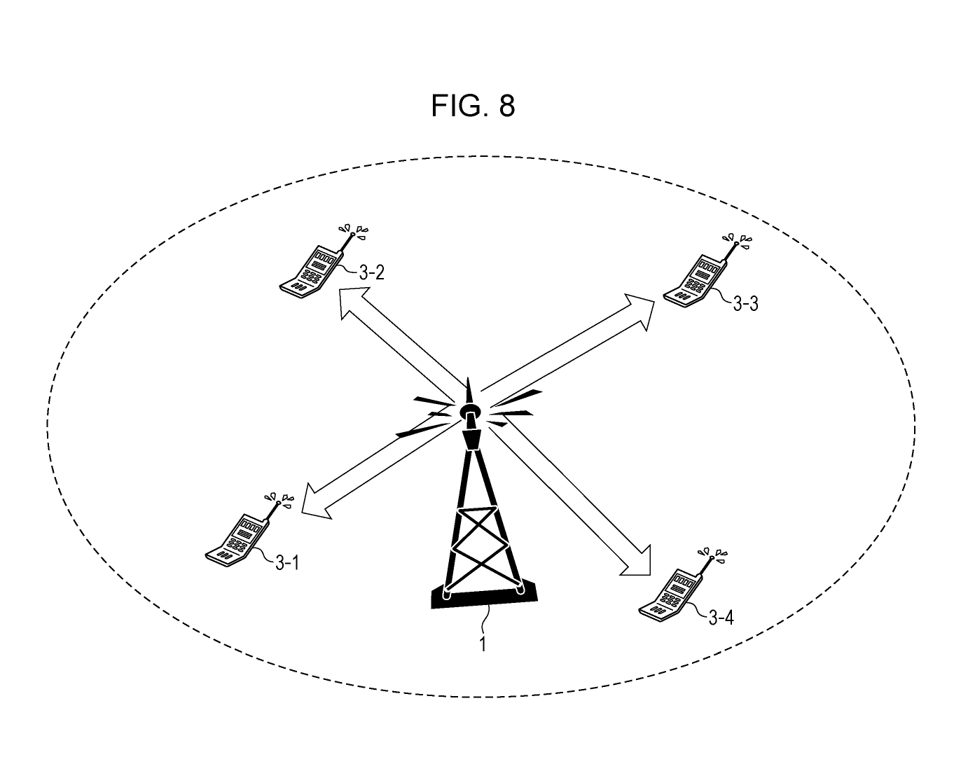

FIG. 8 schematically illustrates a wireless communication system according to a second embodiment of the present invention. In the second embodiment, discussion will be made about a case of the MU-MIMO transmission in which a base station device (wireless transmission device) 1 that has Nt transmit antennas and is capable of the linear pre-coding and the non-linear pre-coding is connected with U terminal devices (wireless receiving devices) 3 each of which has a single receiving antenna (in FIG. 8, U=4, and terminal devices 3-1, 3-2, 3-3, 3-4 are collectively referred to as terminal device 3 also) and Nₜ=U. The base station device 1 obtains channel state information about the terminal devices 3 through control information that is notified by the terminal devices 3 and performs the pre-coding on the transmit data with respect to each of the sub-carriers based on the channel state information. The number of the receive antennas of the terminal device 3 is not limited to one. Further, in this embodiment, although the number of data streams (also referred to as rank) that are transmitted to the terminal devices 3 is one, this embodiment includes cases where the rank is two or more.

In the second embodiment, because inner-cell interference is dominant, discussion will be made while ignoring co-inter-cell interference that is taken into account in the first embodiment.

Before a description about signal processing that is performed by the base station device 1 and the terminal devices 3 in the second embodiment, the cannel state information (hereinafter referred to as CSI also) between the base station device 1 and the terminal devices 3 is defined. In this embodiment, it is assumed that a quasi-static frequency selective fading channel is used. When the complex channel gain of the kth sub-carrier between the nth transmit antenna (n=1 through Nₜ) and the uth terminal device 3-u (u=1 through U) is h_{u,n}(k), a channel matrix H(k) is defined as equation (2). A channel row vector configured by the complex channel gain that is observed by the uth terminal device 3-u is expressed by hᵤ(k)=[h_{u,1}, . . . , h_{u,Nt}].

$$\begin{matrix}[ Math . 2 ] & \\ H ( k ) = ( \begin{matrix}{h}_{1 , 1} ( k ) & … & {h}_{1 , {N}_{t}} ( k ) \\ ⋮ & ⋱ & ⋮ \\ {h}_{U , 1} ( k ) & … & {h}_{U , {N}_{t}} ( k )\end{matrix} ) = ( \begin{matrix}{h}_{1} ( k ) \\ ⋮ \\ {h}_{U} ( k )\end{matrix} ) & ( 2 )\end{matrix}$$

[2.1. Base Station Device 1]

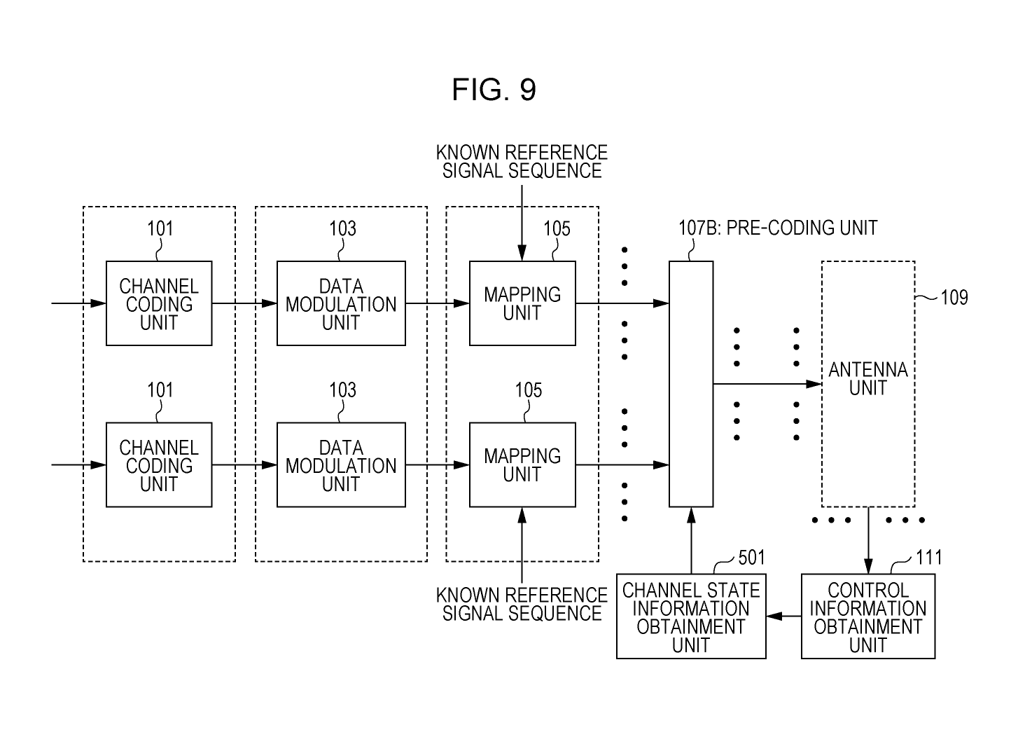

FIG. 9 is a block diagram that illustrates a configuration of the base station device 1 according to the second embodiment of the present invention. As illustrated in FIG. 9, the base station device 1 is configured to include the channel coding units 101, the data modulation units 103, the mapping units 105, the pre-coding units 107B, the antenna units 109, the control information obtainment unit 111, and a channel state information obtainment unit 501. The pre-coding units 107B corresponding to the number N_{c} of the sub-carriers and the antenna units 109 corresponding to the number Nₜ of the transmit antennas are present. The channel coding is performed on the transmit data sequence that is addressed to the terminal devices 3 by the channel coding units 101. The digital data modulation such as the QPSK or the 16QAM is thereafter applied to the transmit data sequence in the data modulation units 103. An output from the data modulation unit 103 is input to the mapping unit 105.

Similarly to the first embodiment, the mapping unit 105 performs mapping of the transmit data and the specific reference signals to appropriate radio resources. However, in the second embodiment, it is necessary to simultaneously transmit the transmit data and the specific reference signals (DMRSs) to the plurality of terminal devices 3. Further, it is necessary to also transmit a cell-specific reference signal (CRS) for estimation of the channel state information that is expressed by equation (2) (the CRS is a reference signal that is transmitted basically without application of the pre-coding. Such a reference signal will hereinafter be referred to as sounding signal also.) Multiplexing methods of the CRS and the DMRSs are not particularly limited. However, the CRS is arranged to be orthogonal among the transmit antennas, and the DMRSs are arranged to be orthogonal among the connected terminal devices 3. As orthogonalization methods, orthogonalization with respect to any of time, frequency, space, and code or a combination of a plurality of orthogonalization technologies may be raised. A description will hereinafter be made on an assumption that the data signal and the reference signals are orthogonally arranged with respect to time and frequency and each of the terminal devices 3 is capable of ideally estimating a desired information in this embodiment.

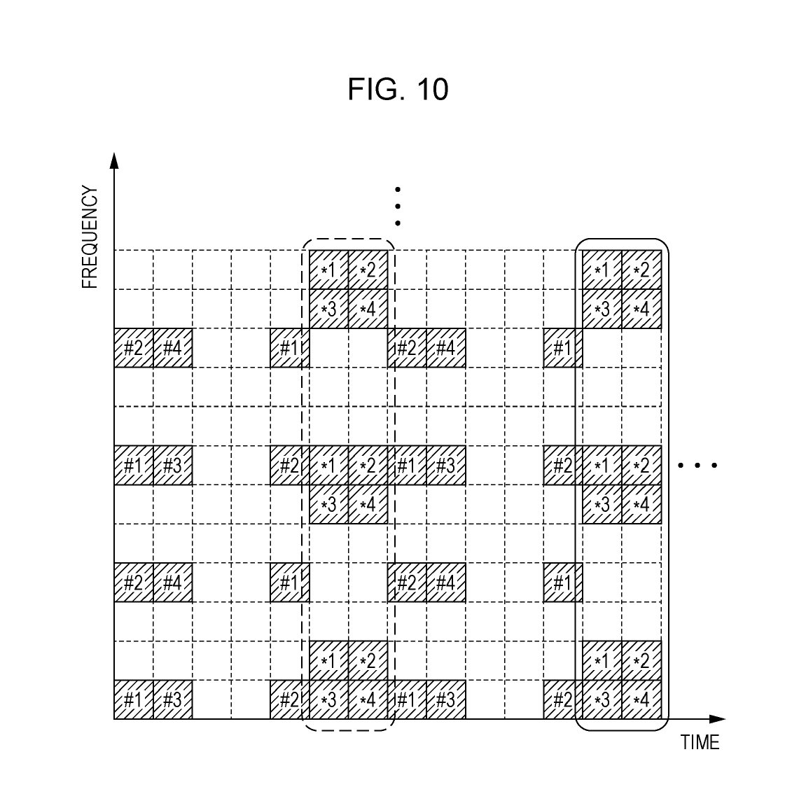

FIG. 10 illustrates an example of the mapping of the transmit data, the DMRSs, and the CRS in a case where the number Nₜ of the transmit antennas is four and the number U of the connected terminal devices 3 is four in the second embodiment of the present invention. The definitions of the axes are the same as FIG. 3. The CRS is transmitted by the nth transmit antenna from the radio resources that are represented by #n, and the signal is not transmitted from the other transmit antennas. Meanwhile, only the DMRSs addressed to the uth terminal device 3-u are transmitted from the radio resources that are represented by *u. The transmit data, a control signal, or another reference signal are transmitted using the other radio resources, and partial pieces of information of those are transmitted to the plurality of terminal devices 3 using the same radio resources.

Although a detailed description will not be made, the DMRSs addressed to the uth terminal device 3-u are originally for estimation of information that is relevant only to the uth terminal device 3-u. However, knowing the receive signal in the concerned radio resources allows the other terminal devices 3 to know the DMRSs addressed to the uth terminal device 3-u. Use of this information allows the terminal device 3 to perform an IUI suppression process such as an interference canceller in a channel compensation unit that will be described later. However, a detailed description about the interference canceller will be omitted below.

Similarly to the first embodiment, the phase rotation that is provided to the signal sequence is changed in accordance with measures of the pre-coding that will be described later for the second DMRS surrounded by the broken line. Details will be described later.

Returning to FIG. 9, outputs of the mapping unit 105 are input to the pre-coding units 107B of the corresponding sub-carriers. A description about signal processing in the pre-coding units 107B will be made later. Hereinafter, signal processing on outputs of the pre-coding units 107B will first be described. The outputs of the pre-coding units 107B of the sub-carriers are input to the antenna units 109 of the corresponding transmit antennas.

A device configuration of the antenna unit 109 according to this embodiment is the same as the device configuration that is illustrated in FIG. 4, performed signal processing is almost the same, and a description thereof will not be made. However, in the second embodiment, a point that the plurality of antenna units 109 are present and an output to the control information obtainment unit 111 is not information that is associated with the interference signal but is information that is associated with the channel state information that is provided by equation (2) is different from the antenna unit 109 of the first embodiment.

[2.2. Pre-Coding Unit 107B]

The signal processing that is performed in the pre-coding unit 107B will next be described.

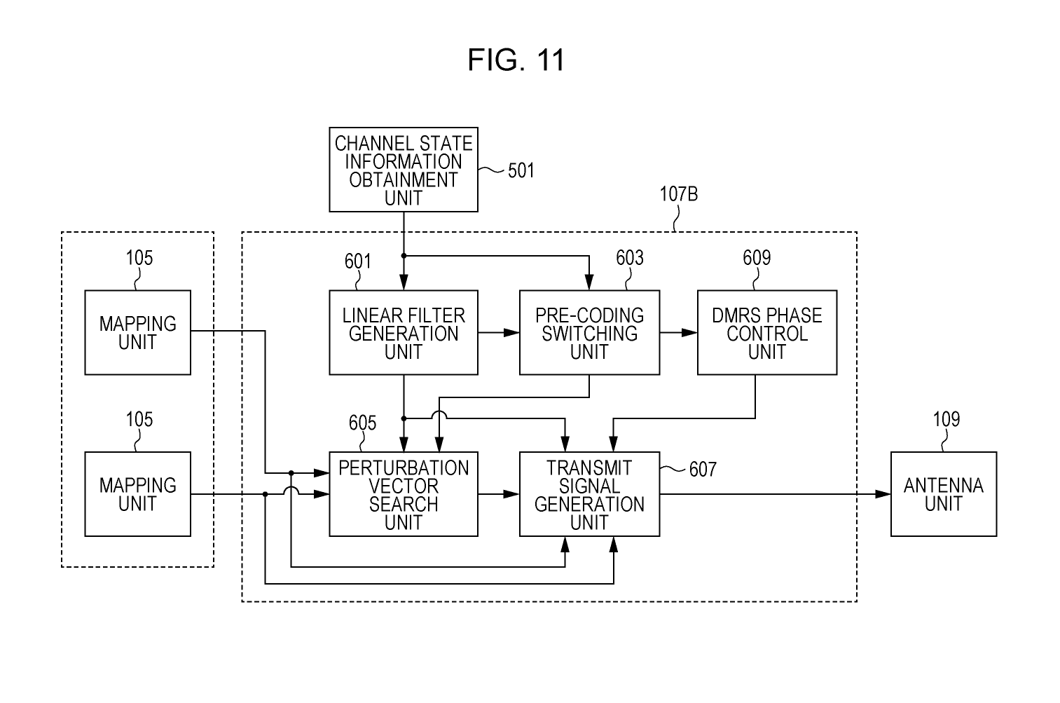

FIG. 11 is a block diagram that illustrates a device configuration of the pre-coding unit 107B according to the second embodiment of the present invention. As illustrated in FIG. 11, the pre-coding unit 107B is configured to include a linear filter generation unit 601, a pre-coding switching unit 603, a perturbation vector search unit 605, a transmit signal generation unit 607, and a DMRS phase control unit 609. A description will first be made about the signal processing in a case where the data signal is input to the pre-coding unit 107B. Here, a kth sub-carrier component {dᵤ(k); u=1 through U} of the output of the mapping unit 105 that contains the transmit data addressed to the terminal device 3 and a channel matrix H(k) of a kth sub-carrier of an output of the channel state information obtainment unit 501 are input. H(k) is based on the above-described CRS, estimated by the terminal device 3, and notified to the base station device 1. In the description made below, it is assumed that H(k) is ideally obtained by the channel state information obtainment unit 501, and an index k will be omitted for convenience.

The pre-coding unit 107B first calculates a linear filter W for suppressing the IUI. Although a calculation method for W is not particularly limited, a linear filter based on zero forcing (ZF) that completely suppresses the IUI may be calculated, for example. In this case, the linear filter is provided by W=H^{H}(HH^{H})⁻¹. In a configuration in which a plurality of data streams are transmitted to the terminal devices 3, the terminal devices 3 are subject to influence of inter-antenna-interference (IAI) where the plurality of data streams addressed to the terminal devices 3 mutually interfere in addition to the IUI. In such a case, the linear filter may suppress both of the IUI and IAI or may suppress only the IUI or the IAI.

Next, the perturbation vector search unit 605 performs a search for the perturbation term. A search method of the perturbation term is determined in accordance with a desired transmission quality and a computation amount that may be realized by a computing device that is included in the base station device 1. For example, in a case where vector perturbation (VP) that may achieve the highest receiving quality is used, the perturbation term may be obtained by solving the minimization problem that is expressed by equation (3).

$$\begin{matrix}[ Math . 3 ] & \\ {z}_{t} = {argmin}_{{z}_{t} ∈ {Z [ i ]}^{U}} \{ {‖ W ( d + 2 δ {z}_{t} ) ‖}^{2} \} & ( 3 )\end{matrix}$$

Here, zₜ=[z_{t,1}, . . . , z_{t,u}]^{T}, and z_{t,u} is the perturbation term that is added to the transmit data addressed to the uth terminal device 3-u.

Incidentally, equation (3) is based on an assumption that all the terminal devices 3 that are connected with the base station device 1 are capable of the modulo computation. However, in an actual system, the terminals that support the modulo computation and the terminals that do not support the modulo computation may mixedly be present. Further, the addition of the perturbation term is effective for maximization of a channel capacity of the entire system but may not necessarily maximize a channel capacity that may be achieved by each of the terminal devices 3. For example, it is reported that higher transmission performances may be obtained by not adding the perturbation term in an environment where the data modulation method is the QPSK and a signal-to-noise power ratio (SNR) is relatively small. This means that control that does not add the perturbation term to all the transmit data addressed to the terminal devices 3 and does not add the perturbation term to a portion of the transmit data may be more effective for improving the spectral efficiency.

Accordingly, in the pre-coding unit 107B according to the second embodiment, the pre-coding switching unit 603 controls whether or not the perturbation term is added to the terminal devices 3. For example, the pre-coding unit 107B performs a process in which the perturbation term is not added to the transmit data addressed to the terminal devices 3 that use QPSK modulation as the data modulation method, or the like. Raising an extreme example, the linear pre-coding may be applied to all the terminal devices 3 in a certain RB, and the non-linear pre-coding may be applied to all the terminal devices 3 in another RB. Information of the pre-coding that is applied to the transmit data is input to the perturbation vector search unit 605 and the DMRS phase control unit 609. Hereinafter, the terminal devices 3 in which the perturbation term is not added to the transmit data are described as the terminal devices 3 to which the linear pre-coding is applied, and the terminal devices 3 for which the addition of the perturbation term is performed are described as the terminal devices 3 to which the non-linear pre-coding is applied.

Although details will be described later, the terminal device 3 needs to correctly know which kind of pre-coding has been applied to the transmit signal addressed to the device in order to correctly demodulate the desired signal in the terminal device 3. Thus, it is not preferable to set a very short period for switching the kinds of pre-coding. In a description made below, similarly to the first embodiment, the kinds of pre-coding are switched for each of the RBs that are configured with 168 radio resources illustrated in FIG. 10.

It is assumed that the perturbation vector search unit 605 appropriately performs the search of the perturbation vector zₜ=[z_{t,1}, . . . , z_{t,u}]T (that is, a portion of z_{t,u} is zero) based on the control information from the pre-coding switching unit 603. The perturbation vector that is searched out is input to the transmit signal generation unit 607, and the transmit signal s=βW(d+2βzₜ) is generated. Here, β is the power normalization term for making the transmission power uniform. The power normalization may be performed for an arbitrary radio resource unit. However, to facilitate the pre-coding for the DMRSs that will be described later, it is preferable to perform the power normalization that provides uniform average transmission power of a certain number of radio resources. Hereinafter, it is assumed that the power normalization is performed by the RB that is a unit for switching the kinds of pre-coding.

A description will next be made about the signal processing in a case where the DMRSs are input to the pre-coding unit 107B. Similarly to the first embodiment, the same pre-coding as the data signal is applied to the DMRSs. However, in a case where the resource allocation discussed in this embodiment is performed, the DMRSs are not spatially multiplexed. Thus, only multiplication of the linear filter W is basically performed in the pre-coding, and the addition of the perturbation term is not performed. Further, the power normalization is performed together with the data signal. Although the DMRSs may be spatially multiplexed, in such a case, control is performed such that the perturbation term that is added to the DMRSs may be estimated by the terminal devices 3 or the addition of the perturbation term is not performed.

However, the DMRS phase control unit 609 to which information of the pre-coding applied to the transmit data is input from the pre-coding switching unit 603 performs control such that the phase rotation is provided to a signal sequence of the second DMRS in accordance with presence or absence of the addition of the perturbation term to the data signal. Specifically, the phase rotation is not provided to the DMRS that is transmitted to the terminal device 3 for which the linear pre-coding is applied to the data signal. On the other hand, a certain degree of the phase rotation is provided to the DMRS that is transmitted to the terminal device 3 for which the non-linear pre-coding is applied to the data signal. Although the phase rotation amount to be provided may be π similarly to the first embodiment, an arbitrary value may be provided. However, it is necessary that the phase rotation amounts are shared by the base station device 1 and the terminal devices 3. If the phase rotation amounts are shared, the phase rotation amounts may be changed by the terminal devices 3. Further, control may be performed such that the phase rotation amount is changed by each of the RBs.

The DMRSs to which the pre-coding and the power normalization are applied are output to the antenna unit 109 similarly to the data signal. The CRS is transmitted without application of any pre-coding. However, the power normalization may be performed similarly to the data signal and the DMRSs.

[2.3. Terminal Device 3]

A device configuration of the terminal device 3 according to the second embodiment is the same as FIG. 6, signal processing in devices is almost the same as the first embodiment, and a description thereof will not be made. However, the CRS is newly input to the channel estimation unit 411. The channel estimation unit 411 estimates the channel state information (see equation (2)) based on the received CRS and inputs a result of the estimation to the feedback information generation unit 413. The feedback information generation unit 413 converts an input channel estimation value into a signal that may be notified to the base station device 1. The signal is finally transmitted from the wireless transmission unit 414 to the base station device 1.

A generation method of feedback information is not particularly limited. However, for example, the channel estimation value may directly be quantized by a finite number of bits, digitally demodulated, and thereafter transmitted. Alternatively, the feedback information may be notified by using a codebook that is shared by the base station device 1 and the terminal devices 3.

In a case where the same pre-coding method is applied to all the terminal devices 3 that are spatially multiplexed by the same RB, the pre-coding method may be notified not by providing the phase rotation to the DMRSs as described above but by providing the phase rotation to the sounding signal such as the CRS. In such a case, the phase rotation is provided to only a portion of the CRS, errors in the channel state information that are estimated from the CRS to which the phase rotation is not applied and the CRS to which the phase rotation is applied are compared, and the pre-coding method may thereby be estimated.

As described above, in the second embodiment, discussion is made about a method that accurately notifies the terminal devices 3 of the applied pre-coding methods by changing the phase rotation amount for the DMRSs in transmission where the plurality of pre-coding methods are selectively or simultaneously performed in the MU-MIMO transmission that performs simultaneous communication with the plurality of terminal devices 3 that are connected with the base station device 1. In the above description, the two kinds of pre-coding that are the linear pre-coding and the non-linear pre-coding are described as examples of the plural kinds of pre-coding. However, kinds of pre-coding to which the present invention relates are not limited to this combination.

For example, discussing only the linear pre-coding, there are various kinds of calculation criteria of the linear filter such as a ZF criterion, an MMSE criterion that minimizes the mean squared error between the transmit signal and the receive signal, and an SLR criterion that maximizes the ratio between transmit signal power and interference power that is given to the transmission power of the other terminals. Further, in this embodiment, the pre-coding is applied that uses the simple synchronous detection for the channel equalization process that is performed by the channel compensation unit 415 of the terminal device 3. However, there is pre-coding that needs a space detection process in the channel compensation unit 415 of the terminal device 3 (for example, block diagonalization method or the like).

In this embodiment, discussion will be made about a wireless communication system in which the terminal device 3 knows which kind of pre-coding is presently applied in accordance with the phase rotation provided to the DMRSs in a case where the various kinds of pre-coding are selectively or simultaneously used. In a case where the base station device 1 is capable of three or more kinds of pre-coding, the phase ration amounts provided to the DMRSs may be associated with the pre-coding methods. For example, in a case where three kinds of pre-coding A, B, and C are applicable, no phase rotation may be provided in a case of the pre-coding A, phase rotation of π/2 may be provided in a case of the pre-coding B, and phase rotation of 3π/2 may be provided in a case of the pre-coding C.

The channel estimation unit 411 of the terminal device 3 calculates the channel estimation values in consideration of all possible phase rotation amounts to the second DMRS, measures errors from the channel estimation value that is estimated from the first DMRS, and may thereby know which kind of pre-coding has been applied.

In the second embodiment, discussion is made about a case where the plural kinds of pre-coding are selectively or simultaneously applied in the MU-MIMO transmission. This embodiment enables addition of a new pre-coding method while backward compatibility is retained and may thus contribute to sophistication of wireless communication systems and contribute to an improvement in the spectral efficiency.

### 3. Third Embodiment

In the first and second embodiments, discussion is made about a case where the terminal device 3 knows which kind of pre-coding has been applied to the received signal in accordance with the phase rotation amount provided to the DMRSs. This may be interpreted as transmitting information other than the channel state information from the base station device 1 to the terminal device 3 by using the DMRS that is originally used for estimation of the channel state information. In the third embodiment, discussion is made about a case where arbitrary information is notified by using phase information of the DMRS.

[3.1. Base Station Device 1]

A configuration of the base station device 1 is similar to the first and second embodiments. Only difference is that the pre-coding unit 107 becomes the pre-coding unit 107C. Signal processing in the pre-coding unit 107C according to the third embodiment will be described below.

[3.2. Pre-Coding Unit 107C]

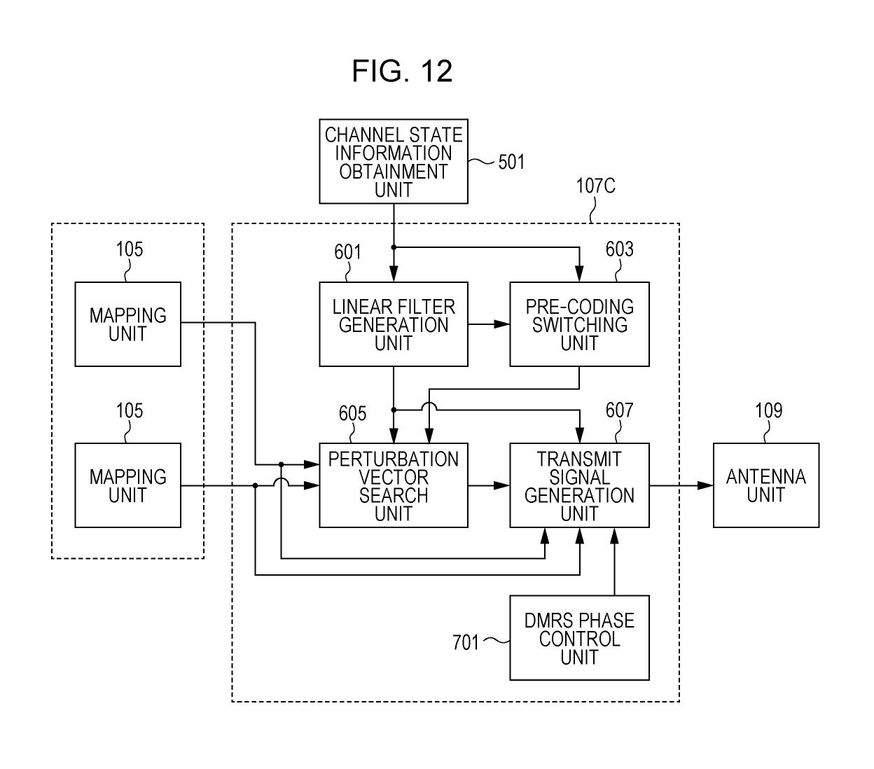

FIG. 12 is a block diagram that illustrates a device configuration of the pre-coding unit 107C according to the third embodiment of the present invention. As illustrated in FIG. 12, the pre-coding unit 107C is configured to include the linear filter generation unit 601, the pre-coding switching unit 603, the perturbation vector search unit 605, the transmit signal generation unit 607, and a DMRS phase control unit 701. Signal processing by the devices is similar to FIG. 11 except the DMRS phase control unit 701, the signal processing in a case where the data signal is input is almost the same as the second embodiment, and a description thereof will not be made (the DMRS phase control unit 701 performs no signal processing when the data signal is input). However, in the third embodiment, it is not necessarily needed that a plurality of pre-coding methods are selectively or simultaneously used. Thus, the pre-coding switching unit 603 may not be used. Further, control may be performed such that the perturbation vector search unit 605 performs no search for the perturbation term, that is, the linear pre-coding is applied.

Signal processing in a case where the DMRSs are input will next be described. Before a detailed description, here, discussion will be made about a data signal that is received by the uth terminal device 3-u and the first DMRS (that is, the DMRS to which particular phase rotation is not provided). Those are given by equations (4).

$$\begin{matrix}[ Math . 4 ] & \\ \{ \begin{matrix}{r}_{u , DATA} = β ( {d}_{u} + 2 δ {z}_{t , u} ) + {η}_{u , DATA} , & for data signal \\ {r}_{u , DMRS} = β {p}_{u} + {η}_{u , DMRS} , & for DMRS\end{matrix} & ( 4 )\end{matrix}$$

Here, η denotes white Gaussian noise that is applied to the receive signals. It is assumed that the non-linear pre-coding has been applied to the data signal while the DMRS is transmitted without spatial multiplexing. The terminal device 3 usually estimates the power normalization term β by dividing r_{u,DMRS} by a known signal pᵤ, uses a result of the estimation to divide r_{u,DATA} by β, thereafter performs the modulo computation, thereby demodulating a desired signal dᵤ.

Here, because β is a real number, if a receive SNR is sufficiently high and |pᵤ|=1, it may be understood that a calculation result of abs(r_{u,DMRS}) is the information itself that is estimated from r_{u,DMRS}. This means that arbitrary phase rotation may be provided to the DMRS while the phase rotation is not shared by the base station device 1 and the terminal device 3. However, in an actual system, the information to be estimated from r_{u,DATA} contains not only the power normalization term β but also a channel state information component that fluctuates on the way from the feedback of the channel state information to reception of the data signal and information about phase rotation that is caused by difference in the frequency between oscillators of the base station device 1 and the terminal device 3. Based on these facts, a method will hereinafter be described in which the base station device 1 notifies the terminal device 3 of arbitrary information by phase rotation information that is provided to the DMRS.

As the resource allocation, the one that is described as an example in the second embodiment and illustrated in FIG. 10 is used. However, although the reason will be described later, it is preferable that the first DMRS and the second DMRS are actually present in a same OFDM signal.

First, in a case where the first DMRS is input to the pre-coding unit 107C, the same pre-coding as the data signal is applied to the first DMRS without providing particular phase rotation or the like, similarly to the first and second embodiments. Then, when the second DMRS is input to the pre-coding unit 107C, the DMRS phase control unit 701 provides the phase rotation to the DMRS based on information that the base station device 1 desires to send to the terminal devices 3.

A way of providing the phase rotation is not particularly limited in the present invention. However, for example, demodulation that is similar to the QPSK demodulation may be applied. That is, by the resource allocation that is raised as an example in this embodiment, the second DMRS has six radio resources for the single RB with respect to the terminal devices 3. Transmitting a signal to which the QPSK modulation is applied to each of the terminal devices 3 enables notification of information of six bits. The other signal processing such as the power normalization is similar to the first DMRS, and a description thereof will not be made.

[3.3. Terminal Device 3]

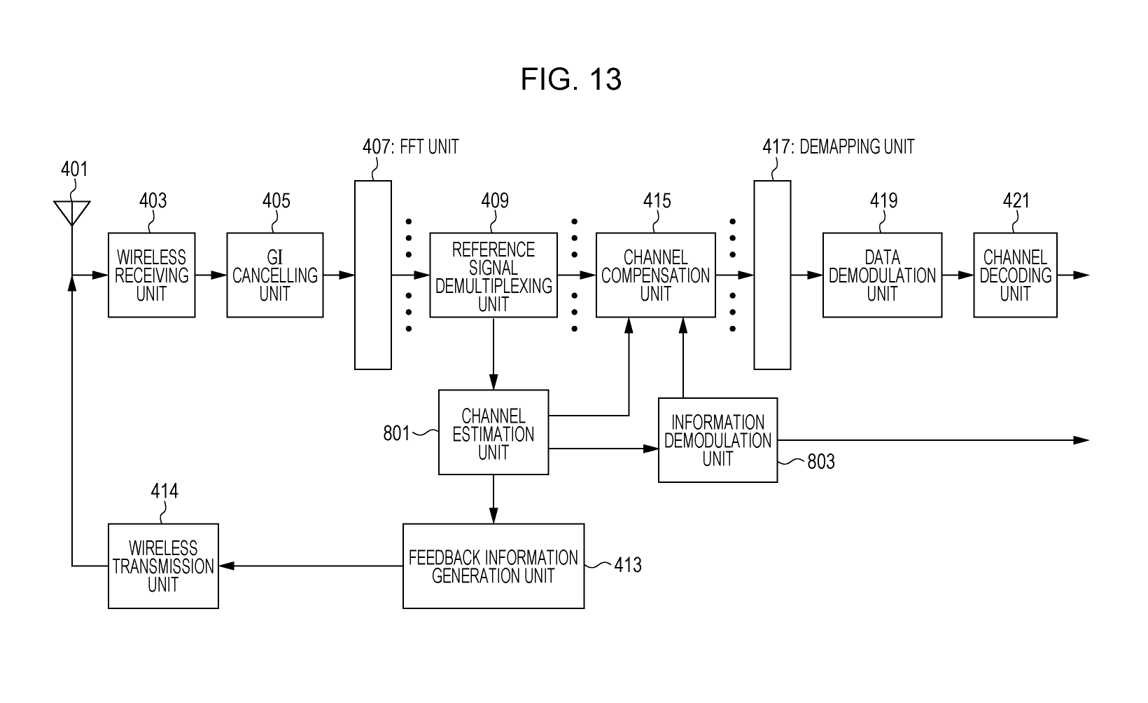

FIG. 13 is a block diagram that illustrates a configuration of the terminal device 3 according to the third embodiment of the present invention. As illustrated in FIG. 13, the terminal device 3 is configured to include the antenna 401, the wireless receiving unit 403, the GI cancelling unit 405, the FFT units 407, the reference signal demultiplexing units 409, a channel estimation unit 801, the feedback information generation unit 413, the wireless transmission unit 414, channel compensation units 415, the demapping unit 417, the data demodulation unit 419, the channel decoding unit 421, and an information demodulation unit 803. The configuration of the terminal device 3 is almost the same as FIG. 6, and signal processing that is performed by the devices is almost the same. However, signal processing in the information demodulation unit 803 and the channel estimation unit 801 and outputs therefrom are different. Thus, only the signal processing in the channel estimation unit 801 and the information demodulation unit 803 will be described below.

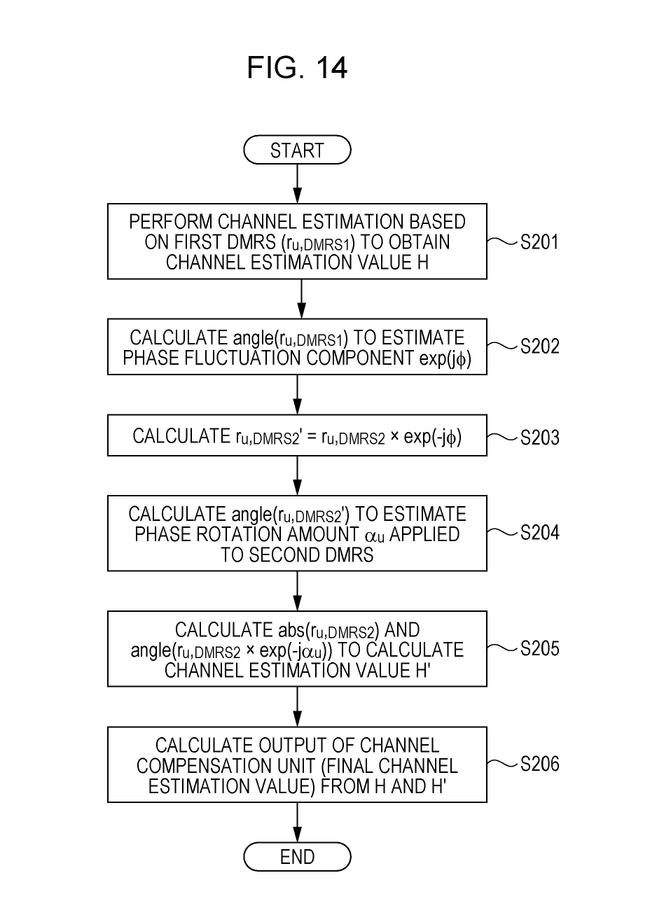

FIG. 14 is a flowchart that explains signal processing in a case where the DMRSs are input in the channel estimation unit 801 of the terminal device 3 according to the third embodiment of the present invention. The signal processing in the channel estimation unit 801 will be described below based on FIG. 14. Signal processing in a case where the CRS is input is similar to the channel estimation unit 411 in the second embodiment, and a description thereof will not be made.

A channel estimation value H is obtained based on the first DMRS (step S201). Here, a receive signal of the uth terminal device 3-u in a case where the first DMRS is received is given by equation (5).

[Math. 5]

r_{u,DMRS1}=ββ′exp(jφ)pᵤ+η_{u,DMRS1} (5)

Here, β′ and φ denote fluctuation components of an amplitude and a phase with respect to the receive signal that are caused by a time fluctuation of the channel or a frequency offset of the oscillator (β′=1 and φ=0 in an ideal environment). A description will be made below while a description about noise components is omitted. In this case, the channel estimation value H is given by β×β′×exp(jφ).

Next, angle(r_{u,DMRS1}) is calculated, and a phase fluctuation component exp(jφ) is estimated (step S202).

Signal processing with respect to the second DMRS is next performed. A receive signal of the second DMRS of the uth terminal device 3-u is given by equation (6).

[Math. 6]

r_{u,DMRS2}=ββ′exp(jφ)pᵤ exp(jαᵤ) (6)

Here, αu is a phase rotation amount that is determined based on information of which the base station device 1 desires to notify the uth terminal device 3-u and is unknown information for the uth terminal device 3-u. The channel estimation unit 801 multiplies the receive signal r_{u,DMRS2} of the second DMRS by exp(−jφ) by using a result of the above estimation to calculate a receive signal r_{u,DMRS2′} from which the phase fluctuation components are removed (step S203). The phase fluctuation components are values that originally fluctuate with respect to time. Thus, in order to perform this signal processing with high accuracy, the first DMRS and the second DMRS are preferably transmitted using radio resources in which the time correlation between the first and second DMRSs is as high as possible.

Next, angle(r_{u,DMRS2}′) is calculated, and αᵤ is thereby estimated (step S204).

Next, abs(r_{u,DMRs2})=β×β′ and angle(r_{u,DMRS2}×exp(−jαu))=0 are calculated, and a channel estimation value H′=β×β′×exp(jφ) that is similar to the first DMRS is thereby estimated (step S205). Finally, an appropriate interpolation process such as averaging is applied to the channel estimation value that is estimated from the first DMRS and the second DMRS, and the channel estimation value is thereafter output to the channel compensation unit 415 (step S206). αᵤ that is estimated in step S204 is input to the information demodulation unit 803.

Signal processing in the information demodulation unit 803 will next be described. The information demodulation unit 803 extracts information from αᵤ by a method that is in advance determined between the base station device 1 and the terminal device 3. For example, in the wireless systems as the first and second embodiments in which the plural kinds of pre-coding are selectively or simultaneously used, a method that associates the value of αᵤ with the pre-coding methods used for the data signals addressed to the terminal devices 3 is possible. In such a case, an output of the information demodulation unit 803 is output to the channel compensation unit 415 or the channel decoding unit 421 (FIG. 13 illustrates a case where the output is made to the channel compensation unit 415). Further, when a phase modulation signal such as the QPSK is used for the second DMRS, the base station device 1 may transmit arbitrary information to the terminal devices 3. In this case, the output of the information demodulation unit 803 is output as information addressed to the uth terminal device 3 without any change.

The above process is the signal processing on the DMRSs in the channel estimation unit 801 and the information demodulation unit 803 according to the third embodiment. In an environment where the time correlation between the radio resources from which the first DMRS and the second DMRS are transmitted is sufficiently high and the receive SNR is sufficiently large, arbitrary information bits may additionally be notified from the base station device 1 to the terminal device 3 by the second DMRS.

The channel coding may be performed on the information bits that are transmitted by the second DMRS and may be performed together with information bits that are originally transmitted as the data signal. However, this indicates that the signal processing in the channel compensation unit 415 is not performed until the channel decoding is performed in a case where the pre-coding method or the like is notified by the second DMRS. Thus, in a case of notifying the control information, it is preferable to perform error control by a method, such as transmitting a same signal plural times, that is simple and does not frequently cause a decoding delay.

In the third embodiment, discussion is made about a case where arbitrary information bits are notified from the base station device 1 to the terminal devices 3 by the second DMRS. The method of the third embodiment enables transmission of the information bits by a portion of the DMRSs and may thus contribute to a further improvement in the spectral efficiency in the MIMO transmission that performs the pre-coding.

[4. Feature Shared by all Embodiments]

The embodiments of the present invention have been described with reference to the drawings in the foregoing. However, a specific configuration is not limited to the embodiments, and the present invention includes designs or the like within a scope that does not depart from the gist of the present invention.

A program that operates in a mobile station device and the base station device 1 that relate to the present invention may be a program that controls a CPU or the like so that functions of the above embodiments related to the present invention are realized (a program that allows a computer to function). In addition, information that is dealt with by such devices is temporarily accumulated in a RAM during a process of the information, thereafter stored in various kinds of ROMs or HDDs. The information is read out, corrected, and written by the CPU as necessary. Record media to store the program may be any of semiconductor media (for example, ROM, non-volatile memory card, and so forth), optical record media (for example, DVD, MO, MD, CD, BD, and so forth), magnetic record media (for example, magnetic tape, flexible disk, and so forth), and so forth. Further, there may be a case where functions of the above-described embodiments are not only realized by executing the loaded program but also functions of the present invention are realized by co-operative processing with an operating system, other application programs, or the like.

Further, in a case where the program is distributed in market, the program may be distributed by storing the program in portable record media and may be transferred to server computers that are connected via a network such as the internet. In such a case, memory devices of the server computers are included in the present invention. Further, a portion or the whole of the mobile station device and the base station device 1 in the above-described embodiments may typically be realized as an LSI that is an integrated circuit. Functional blocks of the mobile station device or base station device 1 may individually be formed into processors, or a portion or all of those may be integrated into a processor. Further, a method of forming the integrated circuit is not limited to an LSI, but the integrated circuit may be realized as a dedicated circuit or a general purpose processor. Further, in a case where a technology of forming an integrated circuit that replaces the LSI emerges as a result of progress of a semiconductor technology, an integrated circuit by the technology may be used.

### REFERENCE SIGNS LIST

1 base station device
3, 3-1, 3-2, 3-3, 3-4 terminal device
5 interference source
101 channel coding unit
103 data modulation unit
105 mapping unit
107, 107A, 107B, 107C pre-coding unit
109 antenna unit
111 control information obtainment unit
113 interference information obtainment unit
201 IFFT unit
203 GI insertion unit
205 wireless transmission unit
207 wireless receiving unit
209 antenna
301 interference suppression unit
303 modulo computation unit
305 pre-coding switching unit
307A, 307B switch
309 DMRS phase control unit
401 antenna
403 wireless receiving unit
405 GI cancelling unit
407 FFT unit
409 reference signal demultiplexing unit
411 channel estimation unit
413 feedback information generation unit
414 wireless transmission unit
415 channel compensation unit
417 demapping unit
419 data demodulation unit
421 channel decoding unit
501 channel state information obtainment unit
601 linear filter generation unit
603 pre-coding switching unit
605 perturbation vector search unit
607 transmit signal generation unit
609 DMRS phase control unit
701 DMRS phase control unit
801 channel estimation unit
803 information demodulation unit

1-12. (canceled)

13. A wireless transmission device that includes a pre-coding device and transmits a data signal and specific reference signals to a wireless receiving device,
wherein the pre-coding device
applies pre-coding to the data signal and plural kinds of specific reference signals based on control information that is obtained from the wireless receiving device,
provides phase rotation to the plural kinds of specific reference signals, and
associates phase rotation amounts of the phase rotation with information that is notified to the wireless receiving device.

14. The wireless transmission device according to claim 13,
wherein the pre-coding device applies the pre-coding to the data signal and the plural kinds of specific reference signals by selectively or simultaneously using any pre-coding methods among plural kinds of pre-coding methods, and
the phase rotation amounts of the phase rotation indicate the used pre-coding methods.

15. The wireless transmission device according to claim 14,
wherein the pre-coding device
provides same phase rotation amounts of the phase rotation to a first specific reference signal and a second specific reference signal in a case where linear pre-coding is applied to the data signal, and
provides mutually different phase rotation amounts of the phase rotation to the first specific reference signal and the second specific reference signal in a case where non-linear pre-coding is applied to the data signal.

16. The wireless transmission device according to claim 13,
wherein the wireless transmission device includes a plurality of transmit antennas and transmits the data signals and the plural kinds of specific reference signals to the plurality of wireless receiving devices,
pre-coding that suppresses interference that is observed by the wireless receiving devices is applied, based on control information that is notified from the plurality of wireless receiving devices, to a portion of the data signals and the plural kinds of specific reference signals that are transmitted to the plurality of wireless receiving devices, and a portion of the data signals that are transmitted to the plurality of wireless receiving devices are transmitted while being spatially multiplexed using same radio resources.

17. The wireless transmission device according to claim 14,
wherein the wireless transmission device
includes a plurality of transmit antennas and transmits the data signals and the plural kinds of specific reference signals to the plurality of wireless receiving devices, and
applies the pre-coding by selectively or simultaneously using any pre-coding methods among the plural kinds of pre-coding to the data signals and the plural kinds of specific reference signals that are addressed to the plurality of wireless receiving devices, and
the phase rotation amounts of the phase rotation indicate the pre-coding methods that are used for the respective data signals that are addressed to the plurality of wireless receiving devices.

18. A wireless receiving device that performs wireless communication with a wireless transmission device,
wherein the wireless receiving device notifies the wireless transmission device of control information, and
receives from the wireless transmission device a data signal and plural kinds of specific reference signals which are addressed to the wireless receiving device and to which pre-coding has been applied based on the notified control information, extracts phase rotation amounts of phase rotation that have been provided to the respective kinds of specific reference signals, and acquires information that is associated with the extracted phase rotation amounts.

19. The wireless receiving device according to claim 18,
wherein pre-coding that selectively or simultaneously uses any pre-coding methods among plural kinds of pre-coding methods has been applied to the data signal and the plural kinds of specific reference signals, and
the used pre-coding methods are recognized and the received data signal is demodulated based on the phase rotation amounts.

20. The wireless receiving device according to claim 19,
wherein a determination is made that linear pre-coding has been applied to the data signal in a case where same phase rotation amounts of the phase rotation have been provided to a first specific reference signal and a second specific reference signal, and
a determination is made that non-linear pre-coding has been applied to the data signal in a case where mutually different phase rotation amounts of the phase rotation have been provided to the first specific reference signal and the second specific reference signal, and the received data signal is demodulated.

21. The wireless receiving device according to claim 20, wherein a determination is made that the non-linear pre-coding has been applied to the received signal regardless of the determination about the pre-coding methods based on the phase rotation amounts, and the data signal is demodulated.

22. The wireless receiving device according to claim 21, wherein a non-linear process that includes modulo computation is performed in a case where the non-linear pre-coding has been applied to the received data signal.

23. An integrated circuit, which is implemented in a wireless transmission device that performs wireless communication with a wireless receiving device and allows the wireless transmission device to execute a plurality of functions, the integrated circuit at least comprising:
a function of obtaining control information from the wireless receiving device;
a function of applying pre-coding to a data signal and plural kinds of specific reference signals based on the control information that is obtained from the wireless receiving device;
a function of providing phase rotation to the plural kinds of specific reference signals; and
a function of associating phase rotation amounts of the phase rotation with information that is notified to the wireless receiving device.
